(19) United States
(12) Patent Application Publication
(10) Pub. No.: US 2015/0066679 A1
(43) Pub. Date: Mar. 5, 2015

(54) METHODS AND SYSTEMS FOR GENERATING MERCHANDISE LEADS

(71) Applicants: Steven A. Mack, Las Vegas, NV (US); Kelly York, Brookings, SD (US); Michael Wishart, Reno, NV (US)

(72) Inventors: Steven A. Mack, Las Vegas, NV (US); Kelly York, Brookings, SD (US); Michael Wishart, Reno, NV (US)

(21) Appl. No.: 14/472,808

(22) Filed: Aug. 29, 2014

Related U.S. Application Data
(60) Provisional application No. 61/873,052, filed on Sep. 3, 2013.

(51) Int. Cl. G06Q 30/06

(52) U.S. Cl. CPC G06Q 30/0613; G06Q 30/0611
USPC 705/26.4

(57) ABSTRACT

A computer-implemented method is provided that includes executing instructions stored on a computer-readable medium. The method includes receiving lead information from a computing device and generating a lead listing based at least in part on the received lead information. The method further includes identifying at least one retailer based on the received lead information and at least one buying preference associated with each retailer of a plurality of retailers, transmitting the lead listing to the identified at least one retailer, and receiving at least one bid from the identified at least one retailer.

### RELATED APPLICATION DATA

This application claims priority to U.S. Trademark Application Ser. No. 61/873,052, filed Sep. 3, 2013.

### FIELD OF THE INVENTION

The field of the invention relates generally to e-commerce and more particularly, to systems and methods for facilitating the use of goods as collateral for loan transactions and the buying and selling of goods, especially where the goods are previously owned.

### BACKGROUND OF THE INVENTION

In retail, leads connect retailers or sellers with possible buyers and, in some contexts, with other sellers. In the modern environment of global e-commerce, leads have taken on a new significance as previously unlikely transactions became possible. The Internet provides a seemingly endless source of leads, which has shifted the challenge from having too few leads to having too many. Retailers are often presented with low quality leads that have a low success rate.

Classifying and targeting groups of Internet users has helped to better match customers and retailers, but retailers are increasingly pressured to expand to diverse sales channels (mobile shopping, computer shopping, bricks-and-mortar, etc.), multiplying their commerce footprint and requiring additional leads. Pawn shops, as a specialized class of retailer, has customers who are buyers, sellers, and sometimes both. Pawn shop inventories are often unique, which enhances the need to connect the right lead with the right pawn shop.

Individual owners of goods may also wish to sell those goods. For example, an individual might purchase a new electronic device and might wish to sell their old device rather than discarding it. While such an individual could attempt to sell their items via garage sale, newspaper add or Internet listing, the methods all have significant problems disadvantages. For example, while services like eBay allow a seller to post a listing for the sale of a good, the process for creating the listing can be difficult and time consuming to the seller. In addition, such a listing does not guarantee that any interested buyers will even see the listing.

Accordingly, there is a need for methods and systems for generating sales leads, especially for pawn leads, that enable retailers to identify leads, add items to their inventory, and sell their inventory using multiple sales channels. There is also a need for owners of items to conveniently and quickly sell their goods.

### SUMMARY OF THE INVENTION

A computer-implemented method is provided that includes executing instructions stored on a computer-readable medium. The method includes receiving lead information from a computing device and generating a lead listing based at least in part on the received lead information. The method further includes identifying at least one retailer based on the received lead information and at least one buying preference associated with each retailer of a plurality of retailers, transmitting the lead listing to the identified at least one retailer, and receiving at least one bid from the identified at least one retailer.

### BRIEF DESCRIPTION OF THE DRAWINGS

FIG. 1 is a block diagram of an exemplary system for generating leads.

FIG. 2 is a block diagram of an exemplary product inventory system for use with the system in FIG. 1.

FIG. 3 is a flow diagram of an exemplary method for use with the system of FIG. 1.

FIG. 4 is a flow diagram of an exemplary method for use with the product inventory system of FIGS. 1 and 2.

FIGS. 5-16 illustrate exemplary screenshots of web pages used to interact with the system of FIG. 1.

### DETAILED DESCRIPTION

The subject matter described herein enables individuals to sell personal items to retailers, especially pawn shops, using an auction format that enables retailers to bid on sales leads. The methods and systems described herein further enable retailers to manage inventories and sell items in inventory using one or more sales channels. In addition, the subject matter described here enables an individual to track a personal inventory and/or to sell items to other individuals directly. Accordingly, retailers are provided with leads for purchasing items for resale and with expanded opportunities to sell purchased items.

More broadly, the subject matter described herein facilitates various transactions involving merchandise, particularly pre-owned merchandise. There are many ways for a merchandise owner to monetize or leverage merchandise, and the subject matter described herein facilitates the promotion, cataloging, searching, and/or transfer of the merchandise using the systems and methods described herein, which enable merchandise acquirers to locate and conduct transactions with the merchandise.

Given the diverse transactions enabled by the systems and methods described herein, labels applied to the parties may be interchangeable and more than one label may apply to a single party. Generally, the individual or organization with the merchandise is considered the “seller” and the individual or organization seeking the merchandise or a transaction with the seller is a “buyer.” In some scenarios, including retail, the buyer may also be the seller. Though customers (i.e., sellers) and retailers (i.e., buyers and sellers) are described throughout, it is contemplated that transactions may be conducted between any seller and any buyer. Thus, the methods and systems described herein are usable in any combination of transactions, including B2B, B2C, C2B, C2C, etc.

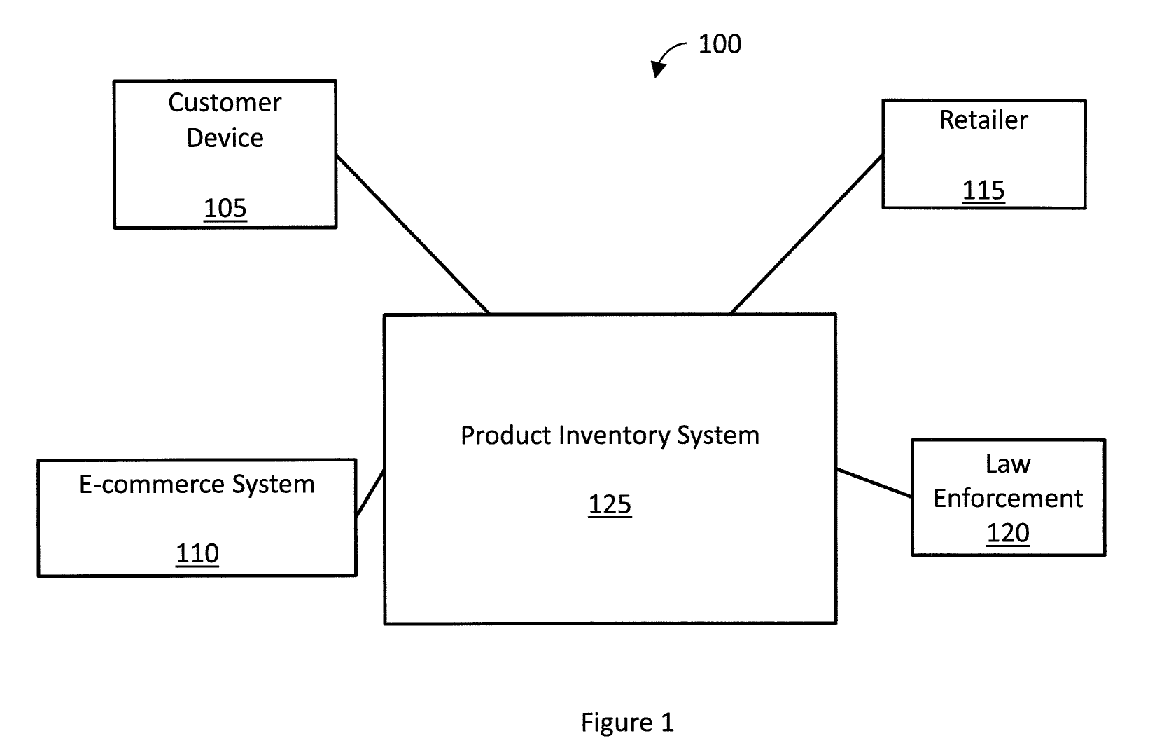

FIG. 1 is a block diagram of an exemplary system 100. The system 100 enables communication and/or commerce between its various components, including one or more of each of the following: a customer or computing device 105, an e-commerce system 110, a retailer 115, and law enforcement 120. A product inventory system 125 may act as a communications hub for the components of the system 100 by facilitating communications and commerce there through. Each component shown in FIG. 1 may have one or more subcomponents that are not shown in FIG. 1.

The product inventory system 125, as explained in more detail herein, contains a repository of products, product details, and product locations. The product inventory system 125 is configured to store details or information about particular items as well as details or information about makes, models, and categories of products. For example, the product inventory system 125 may store information regarding the current condition of a particular mobile communication device (e.g. smart phone, etc.) as well as information regarding attributes of that device, such as screen size, memory size, etc.

The product inventory system 125 may perform one or more functions commonly found in enterprise resource planning (ERP) systems. For example, the product inventory system 125 may track customer orders, purchase orders, inventory levels and location, transactions, and customer history, etc. The product inventory system 125 may provide financial reporting and other accounting functionality. These and other ERP-like functions are well-known in the art and it is contemplated that the product inventory system 125 is an extensible platform that may perform additional functions in the future and may connect to systems now known or to be developed.

As the heart of the system 100, the product inventory system 125 is capable of coordinating communications with one or more components inside and outside of the system 100. Using network links, including the Internet, and other communication links, like telephone lines and leased lines, the product inventory system 125 may provide real-time or batch-based communications. Communications to and from the product inventory system 125 may be based on application programming interfaces (APIs) that facilitate interoperability between disparate systems. In some embodiments, the product inventory system 125 is provided as a “software as a server” (SaaS), however the product inventory system 125 may be implemented in one or more parts and may be provided in a variety of configurations.

In some implementations, and not as a limiting example, the product inventory system 125 is used with a business network of pawn shops and other retailers of used goods. While the product inventory system 125 could be used by or be associated with a single retailer 115, the system 125 has particular advantages when it is associated with or used by multiple retailers 115 or multiple retail locations (i.e. different locations of a common retailer). Inventory in a pawn shop is dynamic and does not follow conventional retail inventory lifecycles of purchase orders, stocking, selling, and re-orders. Inventory in each pawn shop is unique, which presents challenges to pawn shop operators.

One challenge is that pawn shop operators need to make offers on incoming merchandise that are attractive to sellers and that enable the operator to resell the merchandise with a sufficient margin. Operators may rely on pricing guides, past experience, and knowledge of their own inventory to make offers. Another challenge is that pawn shop operators need to connect interested buyers with their unique inventory. For example, a collector looking for certain memorabilia may need to visit multiple pawn shops to find desired items.

The product inventory system 125 solves these and other challenges by linking together multiple pawn shops and retailers, aggregating their data, and making inventory items searchable on the Internet. First, the product inventory system 125 provides an inventory management system that enables a pawn shop to manage and track inventory, intake, and purchases at that pawn shop. Second, the product inventory system 125 analyzes such data for a plurality of pawn shops and provides analytics such as current market prices to enable the pawn shop operator to make informed offers on incoming merchandise. Third, some or all of the aggregated merchandise inventory can be made available on the Internet via a web store front, search engine, etc. Finally, because some pawn shops are required to report certain merchandise to law enforcement, the product inventory system 125 may submit such reports on behalf of the pawn shop.

More specifically, each retailer 115 or a computer system associated with each retailer 115 is communicatively coupled with the product inventory system 125. In some embodiments, the retailer 115 includes a computer system with a web browser that connects to a web site provided by the product inventory system 125. In some embodiments, the retailer 115 includes a computer system with specialized software, such as a point of sale (POS) system, for communicating with the product inventory system 125. Using the communication link, the retailer 115 can query the product inventory system 115 and provide data inputs.

The product inventory system 125 is configured to receive a pricing query from the retailer 115. The pricing query may include details about an item that the retailer 115 is considering purchasing from a seller. For example, the details may include make, model, condition, features, age, color, etc. The product inventory system 125 compares the pricing query with other inventory items and prior transactional data, among other things, and generates a pricing response. The pricing response may include an estimate price or price range and/or prior transactional data. The pricing response is transmitted to the retailer 115.

If the retailer 115 makes a deal to purchase the item, the retailer 115 may submit an inventory addition request that includes the same data as the pricing query as well as purchase price, customer information, item photo, item serial numbers, and/or for sale price. In some embodiments, the pricing query data is not re-transmitted, but instead the retailer 115 provides a reference to the pricing query that enables the product inventory system 125 to associate the pricing query data with the inventory addition request.

Once an item is purchased and received into inventory, the retailer 115 may offer the item for re-sale. The item may be sold in a brick and mortar location of the retailer 115. Alternatively, or additionally, the retailer 115 may cause the product inventory system 125 to offer the item for sale on the Internet. The item may be listed on a web-based storefront associated with the product inventory system 125 and such listing may be accessible and therefore crawlable by a search engine. Thus, Internet buyers may find the item by vising the storefront or by searching using a search engine. A description of the item, including data and/or photos provided by the retailer 115, e.g., in the inventory addition request, is made available by the product inventory system 125. The item description may include additional data from the product inventory system 125, such as specifications associated with the item's make or model. The Internet listing may enable an Internet shopper to purchase the item via the Internet, in which case the retailer 115 may pick, pack, and ship the item to the buyer, or the listing may provide contact information associated with the retailer 115 that enable the buyer to purchase the item directly from the retailer 115, e.g., by phone or in person.

In one scenario, the retailer 115 sells the item to a buyer in the pawn shop. In that case, the retailer 115 may transmit sales data to the product inventory system 125. Because the retailer 115 may be or may include a POS system, the sales data may be automatically transmitted to the product inventory system 125 upon completion of the sales transaction. The sales data may include a sale price and information about the buyer, such as contact information.

In the exemplary embodiment, the product inventory system 125 communicates with the e-commerce system 110. The e-commerce system 110 may include one or more commerce platforms that each enable available inventory associated with the product inventory system 125 to be sold. The e-commerce system 110 may include a catalog-based web store front that includes product listings and product detail pages. Visitors to the web store front may search for particular products or otherwise browse through the available merchandise. Visitors may purchase items by interacting with the e-commerce system 110. The e-commerce system 110 transmits order data to the product inventory system 125. The product inventory system 125 may update the status of the purchased item and cause it to be removed from the e-commerce system 110 such that additional sales of that item are not possible. The product inventory system 125 may communicate order data to the retailer 115 associated with the sold item to enable the retailer 115 to complete the transaction, typically by shipping the item to the buyer.

Alternatively, or additionally, the e-commerce system 110 may include, or may communicate with, commerce platforms that enable available inventory in the product inventory system 125 to be sold via third party websites. For example, the e-commerce system 110 may cause an available inventory item to be listed on eBay, Amazon, or other retail websites. The e-commerce system 110 may offer a particular item via multiple sales channels. Thus, the product inventory system 125, using the e-commerce system 110, enables omni- or multi-channel selling of items in inventory.

In some jurisdictions, second-hand merchandise transactions must be reported to law enforcement agencies. Some reporting may be elective. The product inventory system 125 is configured to detect pre-determined items and report them to law enforcement 130. The pre-determined items may include broad categories such as guns and cell phones, or may be more granular such as makes and models or even as specific as certain serial numbers. Once an item is detected by the product inventory system 125, a law enforcement report is transmitted to law enforcement 120. The law enforcement report may be one of various known reporting formats and may include details about the item, the seller, and/or the buyer. Two-way communication between law enforcement 120 and the product inventory system 125 is possible. Law enforcement 120 may provide the product inventory system 125 with one or more pre-determined items to detect. Law enforcement 120 may respond to the law enforcement report by flagging an item as stolen, to be held, or other classifications.

In addition to facilitating the sale of items by a retailer 115 to a customer/consumer, as described above, the product inventory system 125 may also be configured to facilitate the sale of items by customers/consumers to retailers 115, and thus the product acquisition by retailers 115 from sellers. As indicated above, individuals (i.e. non-retail entities) are constantly seeking to sell items that they own. At the same time, retailers 115, and more particularly pawn shops, rely on a flow of new inventory. The system 100 enables a convenient method for sellers, especially individuals, to offer items for sale and enables a convenient method for retailers 115 to identify and purchase such items.

In other words, the product inventory system 125 may operate as a lead generation system, connecting interested buyers (i.e., retailers 115) with interested sellers (e.g. individuals who wish to sell goods, such as goods that they previously purchased from a retailer). The customer device 105 enables the seller to join a marketplace of sellers and buyers managed by the product inventory system 125. The marketplace, particularly for pawn shops, helps facilitate the exchange of secondhand or previously owned goods. Once entered into the marketplace, the goods may change hands more than once. For example, a pawn shop may buy an item and sell it to a customer who resells the item to a different pawn shop that then resells the item. Using unique characteristics of the item such as a serial number, the product inventory system 125 may track the movement of the item on- or off-line using a transaction history.

The customer device 105 may be a personal computer, such as a laptop, a mobile device, such as a smart phone, PDA, or tablet, or a dedicated computer terminal, such as a kiosk. The customer device 105 at times may be used to purchase items associated with the product inventory system 125. For example, the customer device 105 may use a web browser or mobile application to browse an online store associated with the e-commerce system 110. The customer device 105 may be configured to search for a product from multiple retailers 115 associated with the system 100. A product search query from the customer device 105 may cause the product inventory system 125 to return a list of retailers 115 and/or e-commerce options associated with the e-commerce system 110 that each have the product available. The results may be based on additional parameters, such as item condition, user location, etc.

Moreover, the customer device 105 may be used to transmit a retailer inventory query to the product inventory system 125. The product inventory system 125 may respond to the retailer inventory query with a list of inventory items available from one or more retailers. Accordingly, a user of the customer device 105 may answer the questions: “where can I find a certain product?” and “what items does a particular retailer have for sale?” The user may use the customer device 105 to purchase items associated with a product search query or a retailer inventory query.

In the exemplary embodiment, the customer device 105 is configured to offer an item for sale. The customer device 105 may be configured using a web browser, mobile application, or other technology or technique now known or later developed. At a high level, the customer device 105 is configured to initially collect item information and transmit the item information to the product inventory system 125. Information about the item, combined with information about the customer and other data, may collectively be referred to as “lead information.”

The lead information collected by the customer device 105 may include item details, customer details, and/or other information necessary to conclude a transaction between the customer device 105 and a retailer 115. For example, the customer details may include name, phone number, email address, zip code, desired selling price, preferred transfer method, etc. Information may be input into, or collected by, the customer device 105 using one or more input devices associated with the customer device 105, including a touch screen, a camera, a microphone, a GPS module, a Bluetooth module, etc. The customer device 105 is configured to transmit the information to the product inventory system 125.

In a preferred embodiment of the invention, only a very limited amount of information must be provided by the seller in order to generate the lead. In a most preferred embodiment, a seller need only provide a picture of the item to generate create a lead. For example, a seller may take a picture of the item using the customer device 105 (such as a smart phone, etc.) and then send that picture to the system 125. A seller might be required to register with the system 125 so that seller identification and contact information are known. A seller might then log into the system 125 when they upload or send lead information, whereby the system 125 is aware of the source of the lead.

The product inventory system 125 is configured to receive the item information from the customer device 105. As described in more detail herein, the lead information is made available to one or more retailers 115. In one embodiment, only retailers 115 who are registered with the system 125 are capable of receiving the lead. This ensures to the seller that the retailers 115 who respond to them are safe. In a preferred embodiment, criteria may be applied to determine which retailer(s) 115 the lead information is forwarded to. For example, retailers 115 may indicate their location and types or categories of goods which they are interested in purchasing. The system 125 may apply such criteria, such as to cause the lead information to only be provided to retailers 115 in a particular geographic area (such as close to the seller when the seller wishes to deliver the good when purchased) or to those retailers 115 who have indicated they are interested in purchasing such goods, or other criteria.

The retailers 115 receive the lead information from the product inventory system 125 and may respond with one or more bids for the item. Each bid may include a price and a transportation method, among other things. Transportation methods may include pick up (i.e., where the retailer 115 picks the item up from the seller), drop off (i.e., where the seller drops the item off at the retailer 115), and mail in (i.e, where the seller sends the item to the retailer 115 by courier). A retailer may provide more than one bid for an item. For example, a retailer may offer more money for drop off and less money for pick up.

Bids may be for various transaction types, as requested by the customer and/or as suggested by the retailer. For example, as part of the transaction, the customer may borrow money from the retailer, sell the item for money, trade the item in for store credit, consign the item to the retailer, etc. More specifically, the item may comprise collateral for a loan if the customer borrows money. In a circumstance where the item is used as collateral, the item may not change hands or ownership such that the borrower retains the item. Alternatively, the lender may take possession of the collateral item. Retailers may make bids for more than one transaction type. In some embodiments, the system may also be used by a seller to dispose of an item in other manners, such as by donating the item or trading the item for other goods (for example, a seller might indicate that they wish to trade their Apple iPhone® for a Samsung Galaxy® phone and then wait for a retailer or other seller who is interested in such a trade to respond to the lead). In such cases the user of the system may be trading or donating an item, but is still generally referred to as a “seller” herein.

The bids are received from one or more retailers 115 by the product inventory system 125. The product inventory system 125 transmits the bids to the customer device 105. The customer device 105 causes the bids to be displayed to the user. The user selects a winning bid from among the displayed bids. The winning bid is transmitted to the product inventory system 125 that is configured to put the customer in contact with the winning bidder and to follow-up on the transaction. If the transaction is not completed, a new winning bid may be selected or the bidding process may begin anew.

The product inventory system 125 may be operated by an operator that charges money to use the system 125. In one example operation, a subscription fee is required in order to bid on leads and/or otherwise use the product inventory system 125. In a preferred operation, the retailer 115 is not provided with customer contact information until the retailer 115 is selected as the winning bidder. Upon receiving the selection of a winning bid, the product inventory system 125 may transmit customer contact information to the winning bidder. The product inventory system 125 may also require payment and/or a transaction acceptance from the winning bidder before transmitting the customer contact information. Alternatively, the product inventory system 125 may transmit an invoice or otherwise bill the winning bidder for the lead after a transaction acceptance is received from the winning bidder. The price of a transaction may be based at least in part on the amount of the winning bid or a value associated with the transaction, such as the amount borrowed.

In some embodiments, the lead information is made available to a broader audience than just retailers, including other consumers. For example, the system 100 may cause the lead information to be posted on one or more e-commerce systems 110. The system 100 may be configured to operate an auction or traditional sale for the purchase of the item and conduct the purchase and sell transaction, including collecting payment. Alternatively, or additionally, the system 100 may be configured to accept bids similar to the bids placed by retailers 115 to facilitate a transaction outside of the system 100. In other words, the system 100 may enable consumer-to-consumer transactions via an online catalog, an online auction, or via leads similar to classifieds. For example, a user might generate a lead and receive bids from retailers and/or one or more actual consumers.

In some embodiments, the customer device 105 may be used to create a personal inventory of items. For example, the customer device 105 may be used to take photos of and collect information about household items. Alternatively, or additionally, the customer device 105 may be used to identify existing photos and associate the photos with items. The customer device 105 may be used to transmit or transfer photos associated with items together with information about the items. A user could create an inventory of all personal property of the user of certain property, such as a wardrobe or electronics. The user may organize the personal inventory in a variety of ways: by color, by size, by room, by age, etc. The customer device 105 may be configured to display the inventory using pictures and/or item details. For example, with a pictorial inventory of user's wardrobe entered into the customer device 105, a user may scroll through pictures of dresses in the user's closet. The inventory created by the customer device 105 may be useful to the user in shopping for additional items (e.g., accessories, shoes, etc.) such as to purchase compatible items or prevent duplicate purchases. The personal inventory may be transmitted to the product inventory system 125 for storage and retrieval and/or stored on the customer device 105.

Once entered into the personal inventory, the user of the customer device 105 may selectively transmit items (i.e., as lead information) to the product inventory system 125 to be sold by transmitting the photo that represents the inventory item. For example, from among a selection of items, the user may select one or more items and offer the item(s) for bidding, as described herein. The items may be offered individually or in groups. Thus, the system 100 facilitates convenient and fast selling of personal inventory items. For example, while shopping for a new TV, a user may retrieve a photo and/or information about the user's current TV from the inventory to assist the user in purchasing the new TV, and upon purchasing the new TV, the user might generate a lead for the old TV before leaving the store.

The personal inventory may be updated in various ways, including automatically by the product inventory system 125. As a user sells an item from the personal inventory using the system 100, the personal inventory may be updated to show that the item is currently offered for sale. Upon sale, the item may be removed from the personal inventory. Moreover, the photo and information associated with the item may be transferred from the current owner to the new owner via the product inventory system 125. In other words, items may be added to a user's inventory automatically if the item was purchased using the system 100. In a circumstance where both the seller and the buyer use the system 100, the item information, including any photos, may be removed from the seller's inventory and added to the buyer's inventory. Thus, the buyer, whether a consumer or a retailer, may automatically receive the item information into inventory.

The personal inventory created by the customer device 105 may also be used for insurance purposes, such as to provide evidence of ownership when making a claim. For example, the inventory may include pictures of electronics and jewelry together with item details including serial numbers. In assessing a claim, an insurance adjuster may request an inventory list from the system 100 together with estimated prices for use in valuing the claim. Thus, a synergy is created wherein use of the system 100 by a user facilitates creation of an inventory that aids the user in meeting insurance requirements, and the same inventory of items enables the user to easily sell items to third parties.

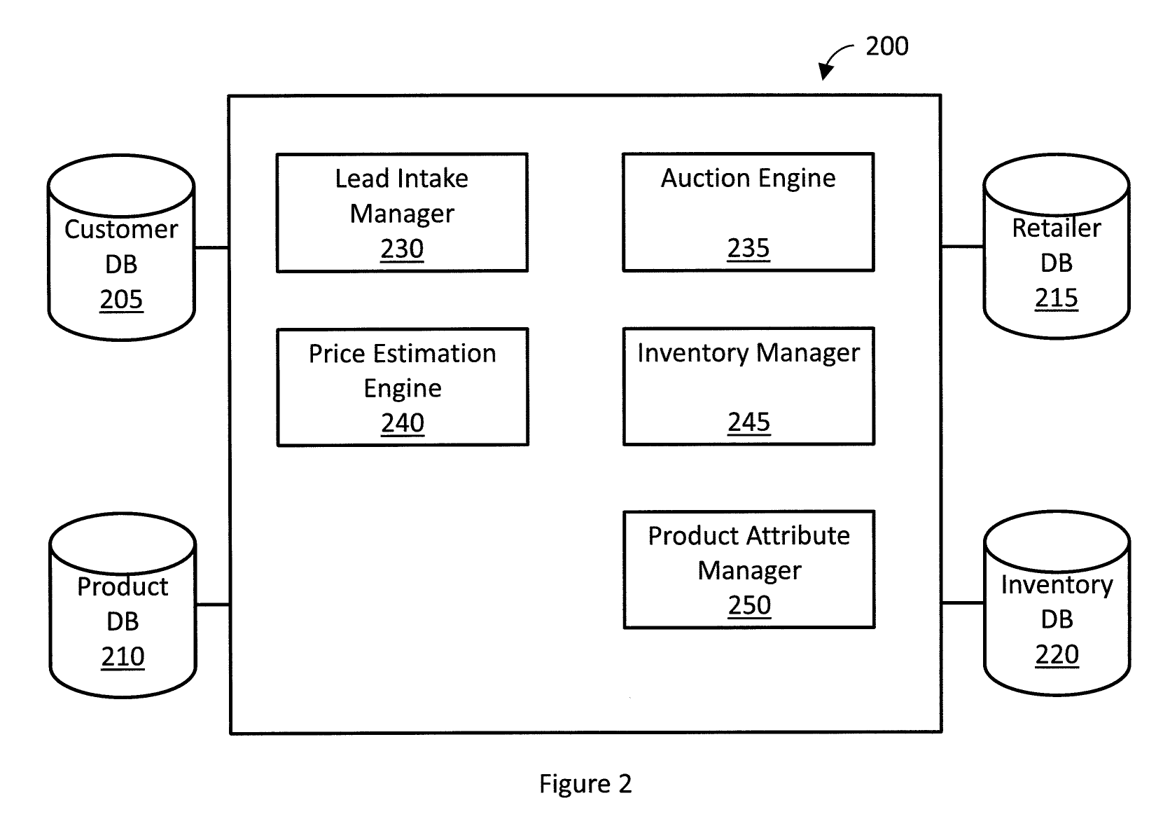

FIG. 2 is a block diagram of an exemplary product inventory system 200 for use with the system 100 illustrated in FIG. 1. The product inventory system 200 may be the same as the product inventory system 125 shown in FIG. 1. The product inventory system 200 includes various systems, components, databases, engines, managers, each of which may be implemented in hardware, software, or a combination thereof and in one or more parts. The system 200 may itself be implemented in one or more parts and may include additional components not shown or described herein.

The system 200 includes a customer database 205, a product database 210, a retailer database 215, and an inventory database 220. The customer database 205 is configured to store customer information about customers associated with the system 200. Customer information may include contact information, identification information (e.g., for reporting to law enforcement), sales and purchase histories, customer relationship management information, and the like.

The product database 210 is configured to store information about products, generally on a stock keeping unit (SKU) basis. That is, the product database 210 may include various product attributes for SKUs, makes, models, etc. Product attributes may include dimensions, weights, technical specifications, colors, etc. Such product attributes may be provided by manufacturers. Other product attributes may be generated by the system 200 based on available data, including recent sales data with prices, incidents of theft, return rates, etc. Some product attributes may be specific to particular items, such as condition, age, number of owners, serial number, etc. Attributes specific to a particular item may be stored in the inventory database 220 and associated with a particular item.

Product attributes may be weighted based on importance to customers, sales demands, etc. and such weights may be stored in the product database 210. For example, it may be determined that customers buying cell phones prefer phones in “excellent” condition over phones with relatively larger storage capacities. Accordingly, for a make, model, SKU, or even class like “cell phones”, condition may be weighted more heavily than storage capacity. The determination of weights may be automatically determined based on sales data or may be manually entered by administrators of the system 200.

The retailer database 215 is configured to store information about retailers, e.g., retailers 115 shown in FIG. 1. Retailer information may include store locations, contact information, licensing/brokerage information, buying preferences, etc. Retailer information may further include technical contact information that enables the system 200 to communicate with the retailer using API endpoints, IP addresses, and the like.

The inventory database 220 is configured to store information about particular items in association with retailers that are stored in the retailer database 215. The particular item information may include item-specific attributes such as product attributes (as described above), location, availability status, price, etc.

In the exemplary embodiment, the system 200 further includes a lead intake manager 230, an auction engine 235, a price estimation engine 240, an inventory manager 245, and a product attribute manager 250. The lead intake manager 230 is configured to receive lead and/or item information from a seller or customer lead, e.g., from customer device 105. Generally speaking, the lead intake manager 230 coordinates communication between the system 200 and the customer.

The auction engine 235 is configured to execute an auction for a lead received from the lead intake manager 230. The auction engine 235 identifies one or more retailers from the retailer database 215 and notifies the identified retailers that a lead is available for bid. The auction engine 235 may use one or more filters and/or information from the customer to identify the retailers, as indicated above. As additional examples, a retailer may have specified that they will not pick up items. The customer may have specified a preference for pick up, in which case the retailer will not have an opportunity to bid on the lead. In another example, the retailer may not be licensed to sell firearms, and so if the item associated with the lead is a firearm, the retailer may not have an opportunity to bid on the lead. In another example, the lead information includes a location of the lead and the auction engine 235 enables retailers within a pre-determined radius of the lead to place bids. A retailer 115 may be permitted to change various lead acquisition criteria with the system and the seller may be permitted to designate various criteria, thus allowing the system to carefully match sellers and retailers.

The auction engine 235 is configured to receive bids and transmit the bids to the customer. The auction engine 235 is further configured to receive a bid selection from the customer. The auction engine 235 notifies the winning bidder and transmits identifying information about the winning bidder to the customer. The winning bidder is given, by the auction engine 235, details about the lead including contact information. The auction engine 235 may confirm with the customer and/or the retailer that the transaction took place and may receive a final sales price, which may be different than the bid price. For example, after the retailer examines the item, the retailer may adjust the offer.

The price estimation engine 240 is configured to estimate a value for a particular item based on information available to the system 200. For example, when the lead intake manager 230 receives a lead, the price estimation engine 240 may use lead information and product information available in the product database 210 to estimate a price. The price estimation engine 240 may use weighted product attributes to compare a particular item against recent sales data to identify an estimated retail price. The estimated retail price may be provided to retailers by the auction engine 235 as part of the bidding process.

The inventory manager 245 is configured to receive inventory information from retailers and store the information in the inventory database 220. The inventory manager 245 may receive a transaction confirmation from the auction engine 235 and place the associated item or items into the inventory associated with the auction winner. Thus, items transferred via an auction may be automatically entered into inventory.

The product attribute manager 250 receives attributes, weights, and other data relating to makes, models, SKUs, and particular items and stores data in the product database 210 and/or the inventory database 220. In some cases, a retailer and/or an administrator or user of the system 200 may provide data to the product attribute manager 250. In some cases, lead information received by the lead intake manager 230 may be transmitted to the product attribute manager 250 upon conclusion of a sale, as identified by the auction engine 235. Thus, particular item attributes, such as condition, sales prices, etc. may be stored in the inventory database 220 in association with the particular item in inventory.

During operation, an individual or user with a customer device, e.g., customer device 105, wanting to sell an item may use a web browser or an application on the customer device to enter item information. The user may begin the process by taking a picture of the item using the customer device. The user may already have an account associated with the system 200 and the account details may be stored in the customer database 205. At some point, the user may log in to retrieve the account details and associate the lead information with the account. The account details may include customer contact information, in which case the user would not need to enter such details again.

The user may identify the item by make, model, SKU, barcode, or other identifier. The customer device may provide the identifier to the system 200. The system 200 may identify the product in the product database 210 and return product information, including stock photos, to the customer device from the product database 210. At this point during operation, the user may submit the lead to the system 200. However, additional information may be entered by the user, such as a free-form text description. For example, the user may provide the condition of the item and/or other item-specific information. The user may provide bid preferences, such as how far the user is willing to travel to drop off an item, and what type of bids the user will accept (e.g., pick up, drop off, mail in). The item/product information, together with the item-specific information and bid preferences, may be transmitted to the lead intake manager 230.

The lead intake manager 230 may cause the price estimation engine 240 to generate an estimated price for the item. The lead intake manager 230 notifies the auction engine 235 that a new lead has arrived for auction. The auction engine 235 receives the lead information, including the bid preferences, and identifies one or more retailers to participate in the auction. Retailers may be notified by the auction engine 235 using known notification methods, or a retailer may discover an auction by searching through open auctions available from the auction engine 235. The auction may have a time limit, at which time bids will no longer be accepted and the winner will be identified. The user may specify the duration of an auction.

In some embodiments, the lead intake manager 230 receives leads from third party systems. For example, the lead intake manager 230 may use an API to receive leads from affiliate marketers or leader providers. The leads from third party systems may be presented to the retailers using the auction engine 235. In such embodiments, the lead intake manager 230 coordinates the transaction between the third party system and the retailers.

The auction engine 235 receives bids from the retailers. Each participating retailer may provide one or more bids. For items that include multiple parts (i.e., bundles), the retailers may bid on the component parts. Each retailer may provide a bid for each available transport method.

In some embodiments, retailers may have specified rules under which bids may be automatically generated. For example, a retailer may provide a rule that for certain makes of cell phones in certain conditions (e.g., good to excellent), a bid is automatically generated at a pre-determined price or at a price based on an estimated price provided by the system 200.

At the close of the auction, the bids received by the auction engine 235 are transmitted to the customer device. At this point during operation, the user typically will not know the identity of the bidders. Based on the offer price, transport method, and other factors, the user will select a winning bidder. The selection is transmitted to the auction engine 235, which then facilitates initial communication between the user and the winning bidder or retailer.

In the exemplary embodiment, the system 200 is acting as a lead generator and so merely introduces the user to the retailer by exchanging contact information upon a successful bid. Alternatively, or additionally, the system 200 may accept payments from the retailer and transmit payments to the user. The system 200 may act as an escrow, holding payment until the retailer is satisfied.

The auction engine 235 transmits a transaction confirmation message to the user and/or to the retailer to confirm that the transaction was completed. The transaction confirmation message may be transmitted by email, text message, web page notification, or other similar notification methods. If the transaction is not confirmed, the user may be provided an opportunity to select from the list of bids again to make another attempt at completing the transaction. If the transaction is confirmed, the auction engine 235 notifies the inventory manager 245 that the item has been received into inventory for the winning bidder. The inventory database 220 is correspondingly updated. The auction engine 235 also notifies the product attribute manager 250 about the transaction and provides item-specific information as identified by the user and/or as modified by the retailer (i.e., upon examination).

Once entered into inventory, the system 200 may cause the item to be offered for sale using an e-commerce system, e.g., the e-commerce system 110 of FIG. 1. Thus, the system 200 enabled a user to identify an interested buyer and to sell an item. From the retailer perspective, the system 200 generated a lead for the retailer that the retailer was interested in (as evidenced by the retailer making bids based on information sufficient to pique the retailer's interest), and enabled the retailer to track the item in inventory and offer it for sale in multiple sales channels.

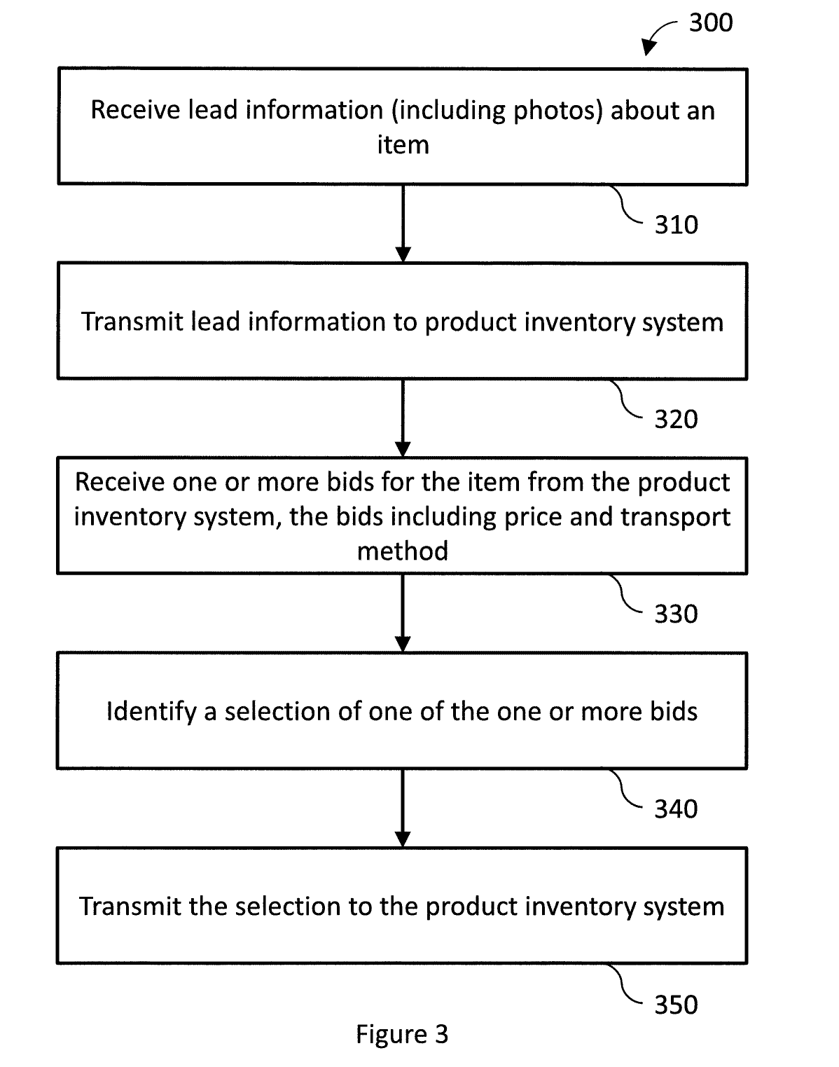

FIG. 3 is a flow diagram of an exemplary method 300 for use with the system 100 of FIG. 1. One or more steps of method 300 may be executed by a customer device, e.g., customer device 105. In step 310, the customer device receives lead information from a seller, such as via the seller's input of information to the device. Lead information may include product information as well as customer information, such as account credentials and/or contact information. The customer device may receive the lead information from any of its various input devices, including cameras, keyboards, mice, GPS modules, and/or touchscreens. As indicated above, in a preferred embodiment the lead information simply comprises one or more photographs of the item.

The lead information is transmitted, in step 320, to a product inventory system, e.g., the product inventory system 125 of FIG. 1. The lead information may be transmitted using any transmission technique now known or later developed, including transmission over the Internet, cellular networks, etc. using any protocol (e.g., TCP/IP) and mechanism (e.g., API, remote procedure call, etc.).

In step 330, the customer device receives one or more bids from the product inventory system. The bids may be received simultaneously or in real-time as the product inventory system receives bids from retailers. The bid includes at least an offer price and a transport method (i.e., pick up, drop off, mail in). In an alternative embodiment, the system 125 may identify the one or more best bids from various bids which are received from the retailers 115 and the best bid or bids may be forwarded to the seller. For example, the system 115 might receive a bid of $25 from retailer A with a pick-up option and a bid of $30 from retailer B also with a pick-up option. Because both bids include the pick-up option, the system 125 may automatically designate the higher value bid from retailer B as the best bid and thus only forward that bid to the customer. If the system 125 received a bid from retailer A of $25 with a pick-up option and a bid from retailer B of $30 with a drop-off option, the system 125 might forward both bids to the seller because they include different criteria (thus allowing the seller to decide which bid is more enticing to them).

In step 340, the customer device identifies one or more of the bids as the winning bid. Typically, the winning bid is identified by a selection provided by the user. The user may select a winning bid from a list of received bids.

In step 350, the customer device transmits the bid selection to the product inventory system. A unique identifier, such as a number, may be assigned to each bid. The bid identifier may be used throughout the system to uniquely identify the bid without necessarily revealing the source of the bid.

Though not shown in the flowchart, after the customer has accepted a bid, the winning bidder is preferably notified by the system 125 and is provided the contact information of the seller. At that time, the retailer 115 can contact the seller in order to finalize the transaction. This might comprise, for example, the retailer 115 phoning the seller and requesting additional details regarding the good and/or confirming the steps necessary to complete the sale. This might also comprise a request by the retailer 115 for additional information regarding the good, such as a request that the seller now provide detailed information regarding the good such as additional pictures, condition information, serial or part number information or the like.

In this regard, while the system 125 facilitates the matching of a seller to a buyer/retailer using a simplistic lead, in a preferred embodiment the system 125 and method do not require that the parties ultimately consummate the sale. The consummation of the sale may be dependent upon additional criteria, such as confirmation by the retailer 115 of the condition of the good, its conformance to the picture that was provided as the lead, to the seller dropping off the good, etc.

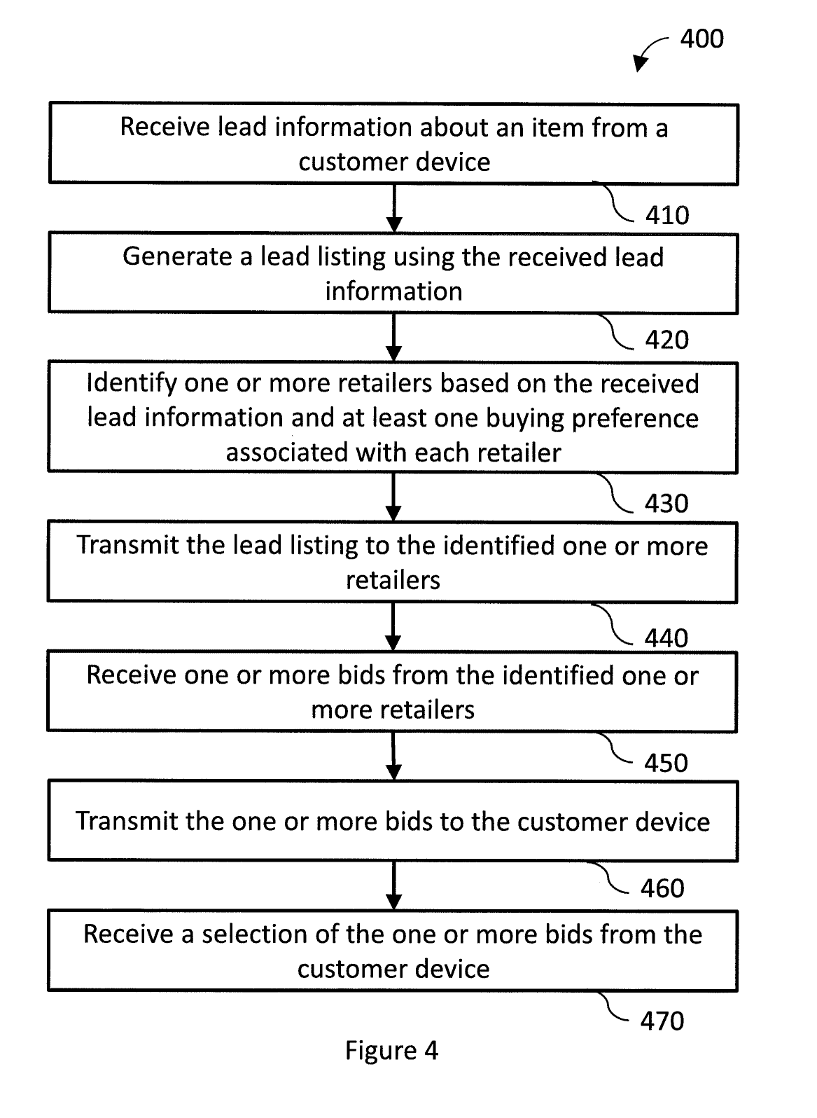

FIG. 4 is a flow diagram of an exemplary method 400 for use with a product inventory system, such as the product inventory system 125 of FIG. 1 or 200 of FIG. 2. In step 410, the product inventory system receives lead information from a customer device, such as customer device 105. In step 420, the product inventory system generates a lead listing using the lead information received in step 410. The lead listing may include the lead information and any other information available to the product inventory system, including non-identifying information about the customer, a transaction history of the particular item, sales data for similar items, an estimated price, etc.

In step 430, the product inventory system identifies one or more retailers based on the lead information and at least one buying preference associated with each retailer. The retailers may effectively filter incoming leads by providing to the product inventory system buying preferences, including desired categories of goods, locations, item condition, etc. In step 440, the product inventory system transmits the lead information to the retailers identified in step 430.

In some embodiments, the product inventory system may transmit the lead information to the identified retailers simultaneously. In other embodiments, the product inventory system may transmit the lead information to the identified retailers in an order. The order of the retailers may be based on fees paid by retailers to receive leads sooner than other retailers, a transaction history of the retailers (i.e., higher volume retailers receive leads earlier), etc. Rather than using a pre-determined order, the product inventory system may transmit lead information using a round-robin, Monte Carlo, or other method to generate an order of retailers. Retailers may be identified by the system to receive lead information based on the time of day and/or whether the retailer has reached a cap for a number of bids placed within a time period, such as one day.

In step 450, the product inventory system receives one or more bids from the identified retailers. The bids may each include a price and a transport method (i.e., drop off, pick up, mail in). The bids may be received in any order and not necessarily simultaneously. In step 460, the received bids are transmitted to the customer device. The bids may be transmitted in batches or as they are received. In step 470, the product inventory system receives a selection of the one or more bids from the customer device. At this point, the customer and the retailer have been matched by the product inventory system, and the product inventory system may transmit the contact information of the parties to the opposing party such that they may complete the transaction by exchanging the item for money or trade. The product inventory system may transmit a confirmation request to the parties to confirm that the transaction took place.

Accordingly, and as a benefit over the prior art, the subject matter described herein provides efficient and cost-effective methods and systems for generating leads and exchanging secondhand goods. As described herein, the customer is enabled to quickly receive bids for an item and the retailer is enabled to identify leads and bid on items for purchase. The retailer may then track the item as part of the retailer's inventory, all or some of which may be sold online or through other channels.

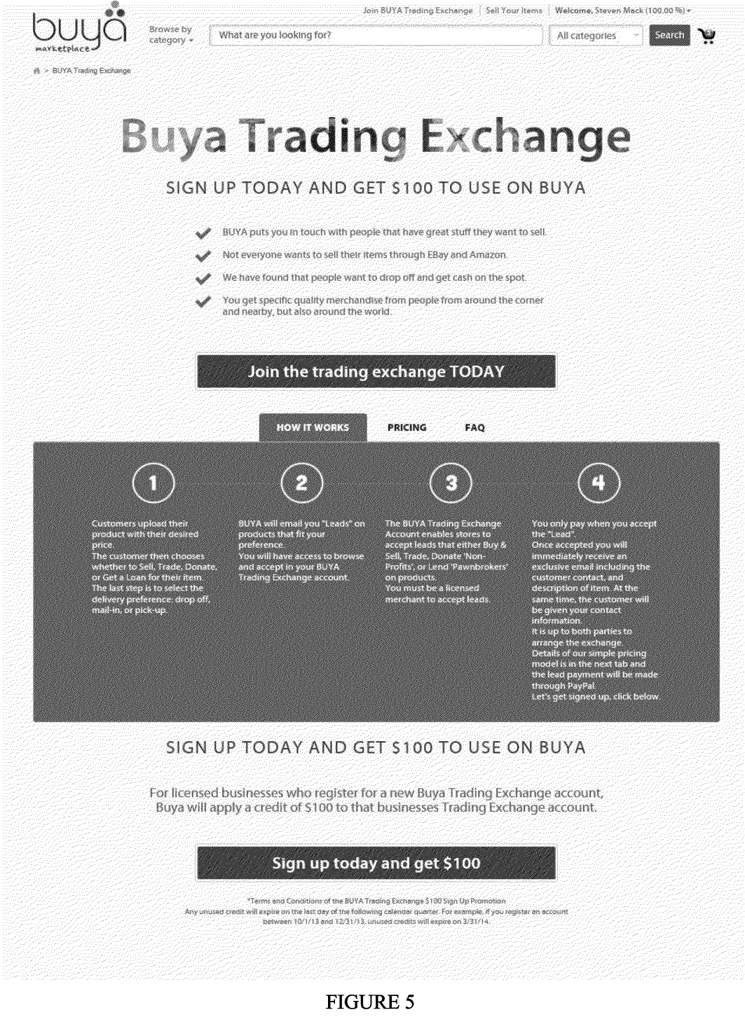

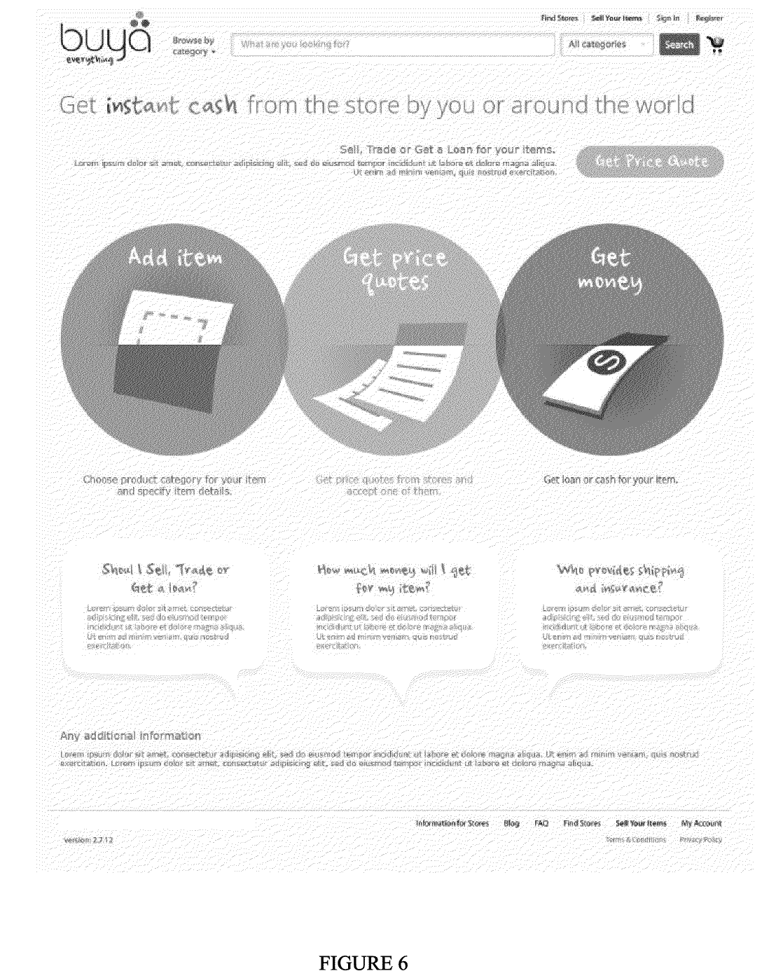

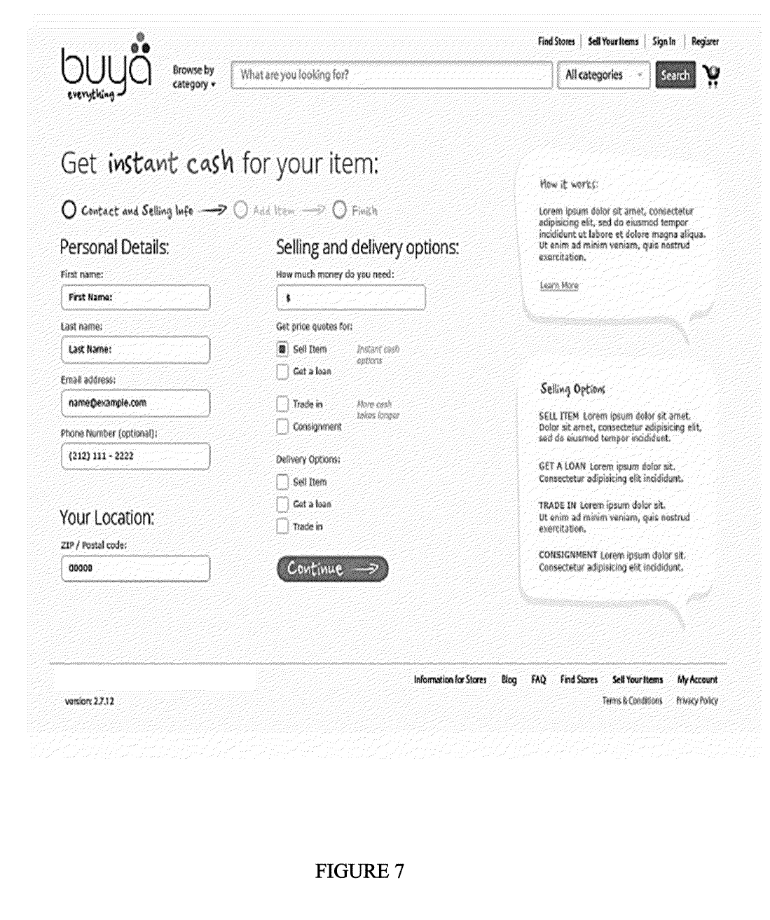

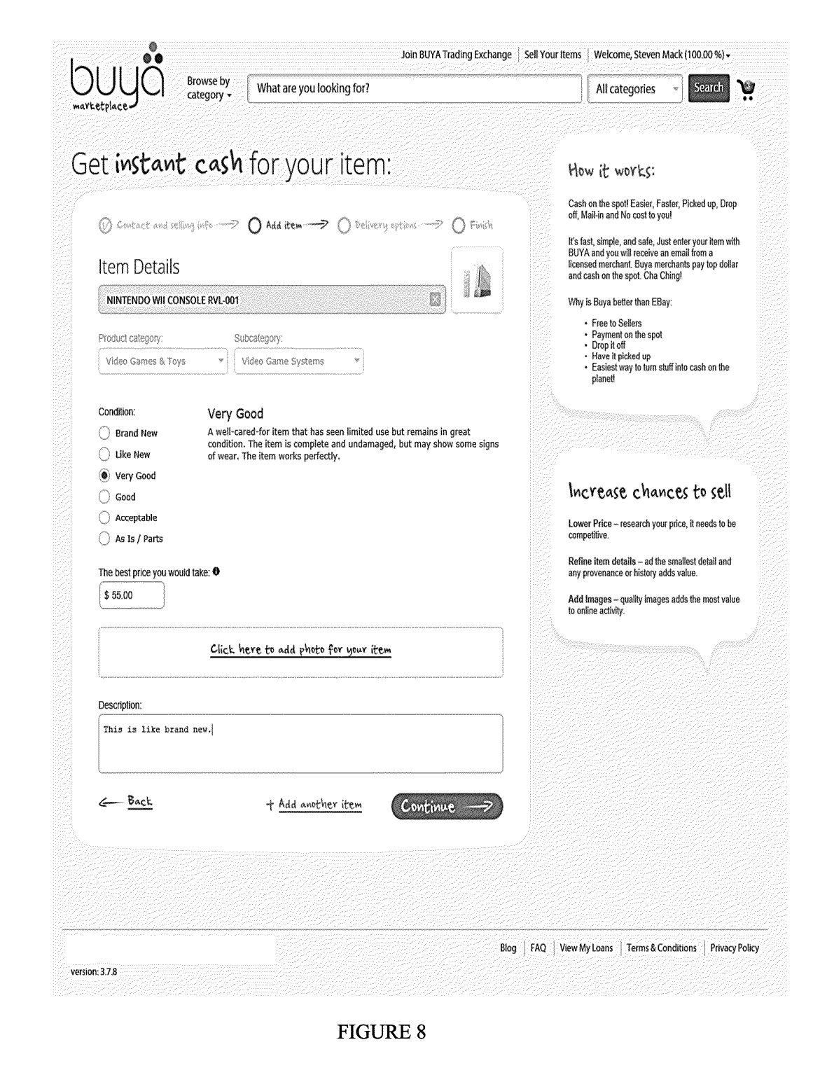

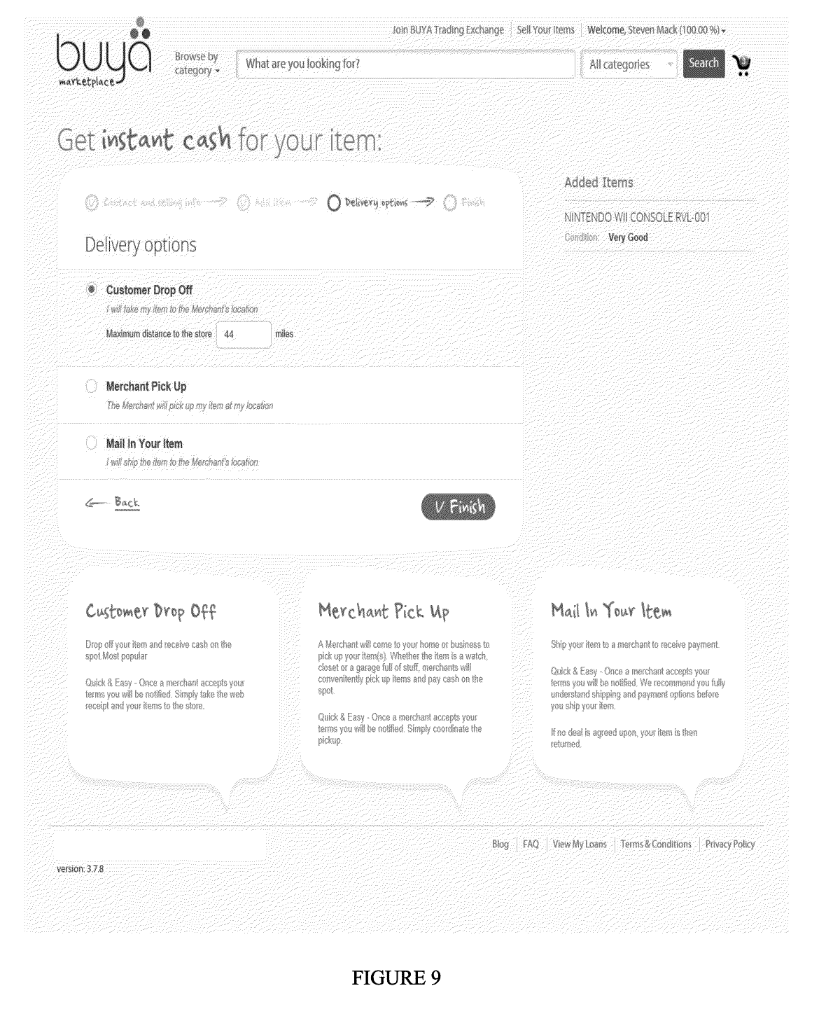

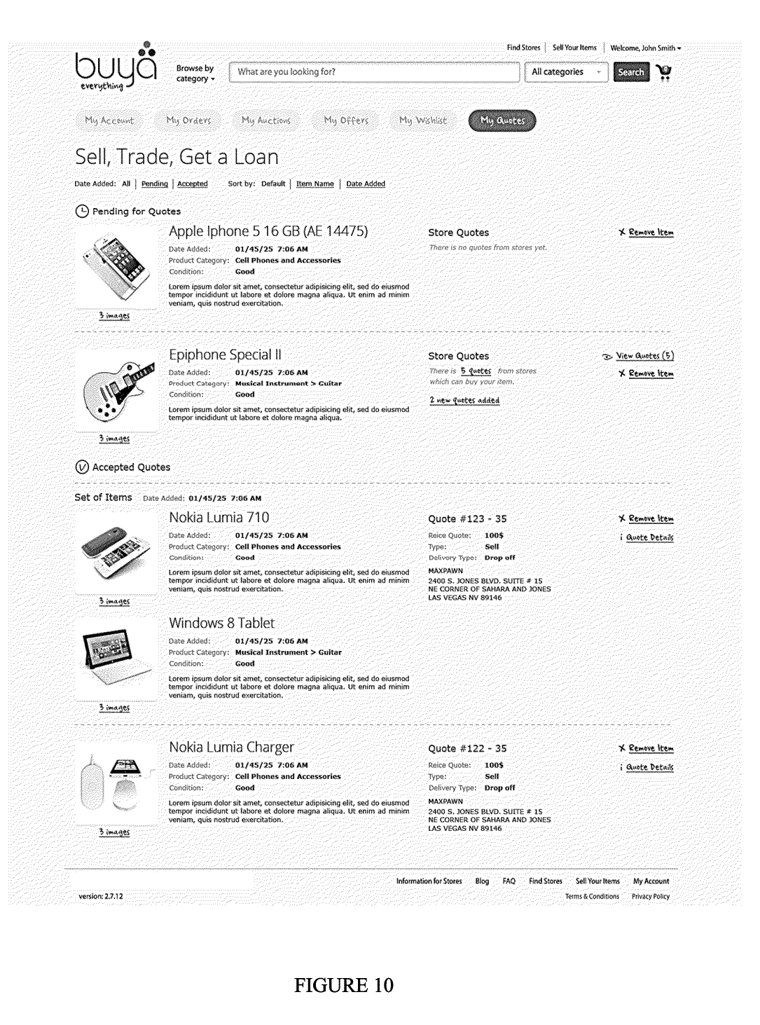

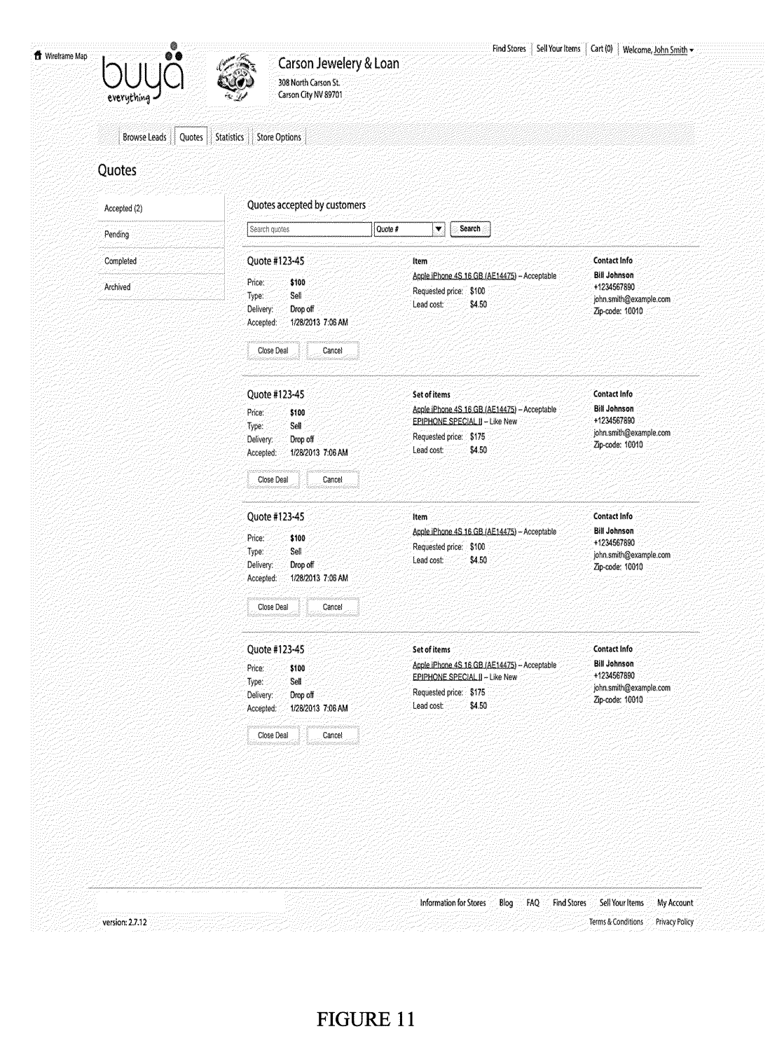

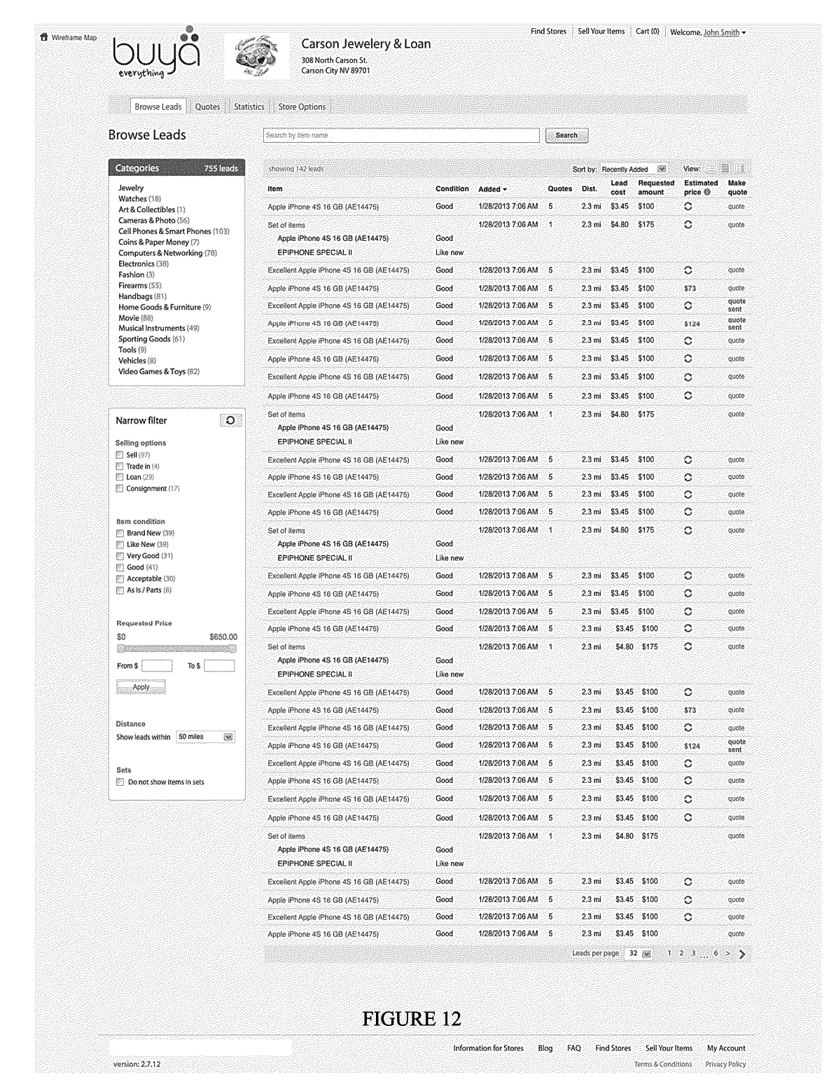

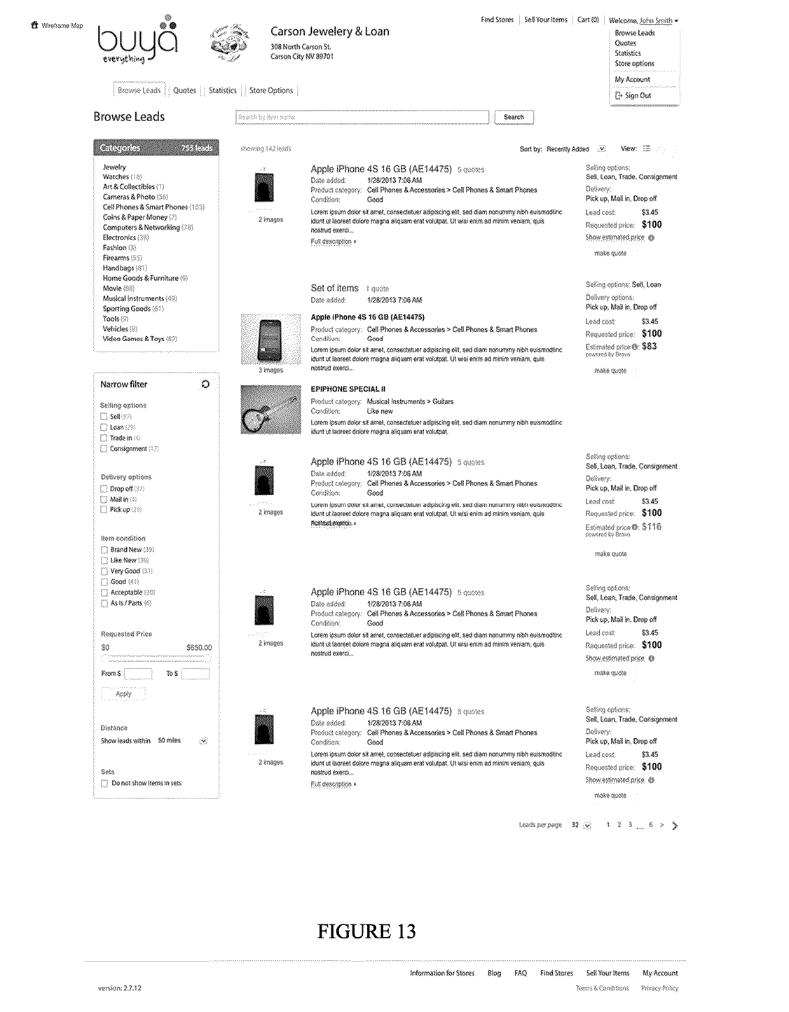

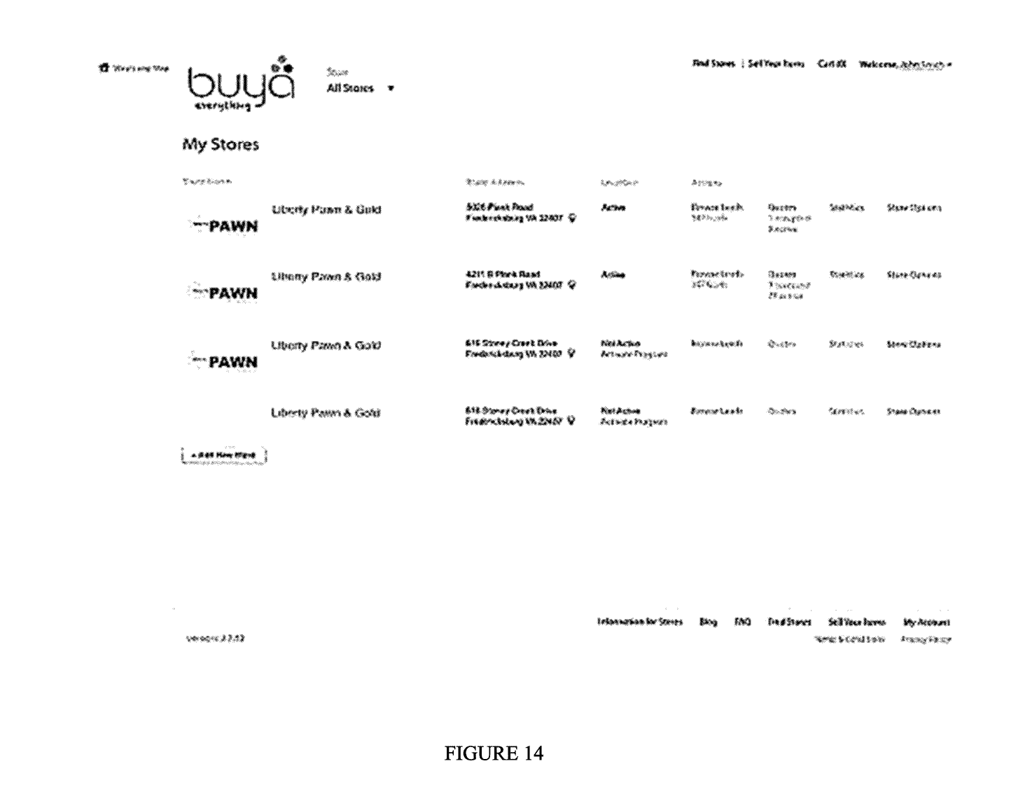

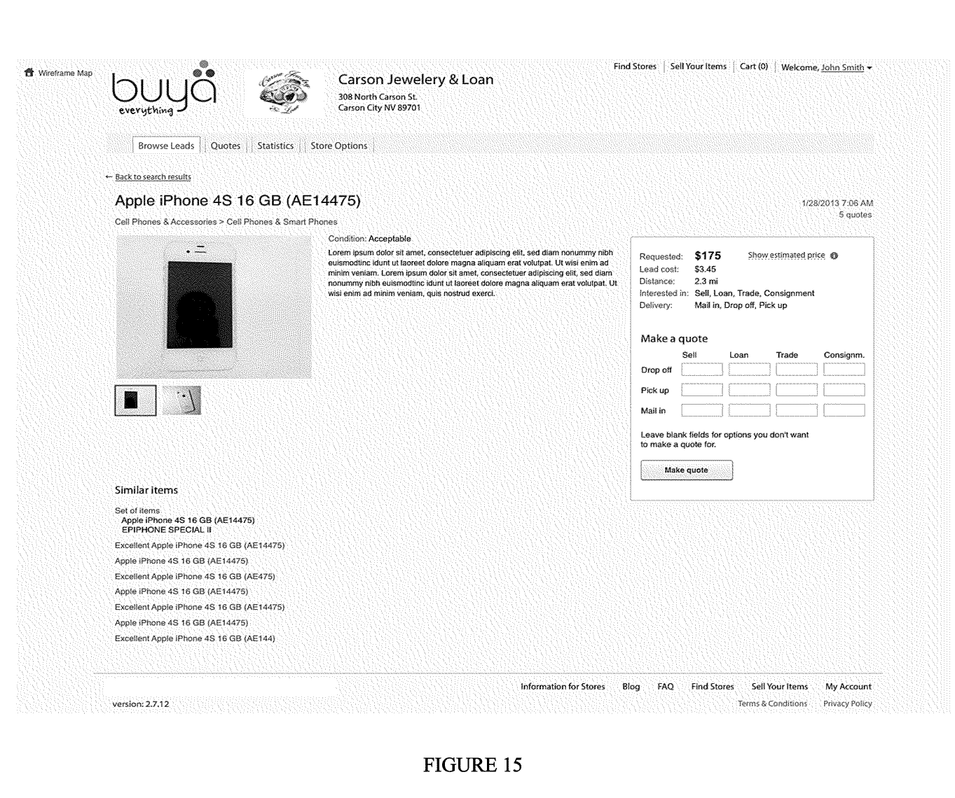

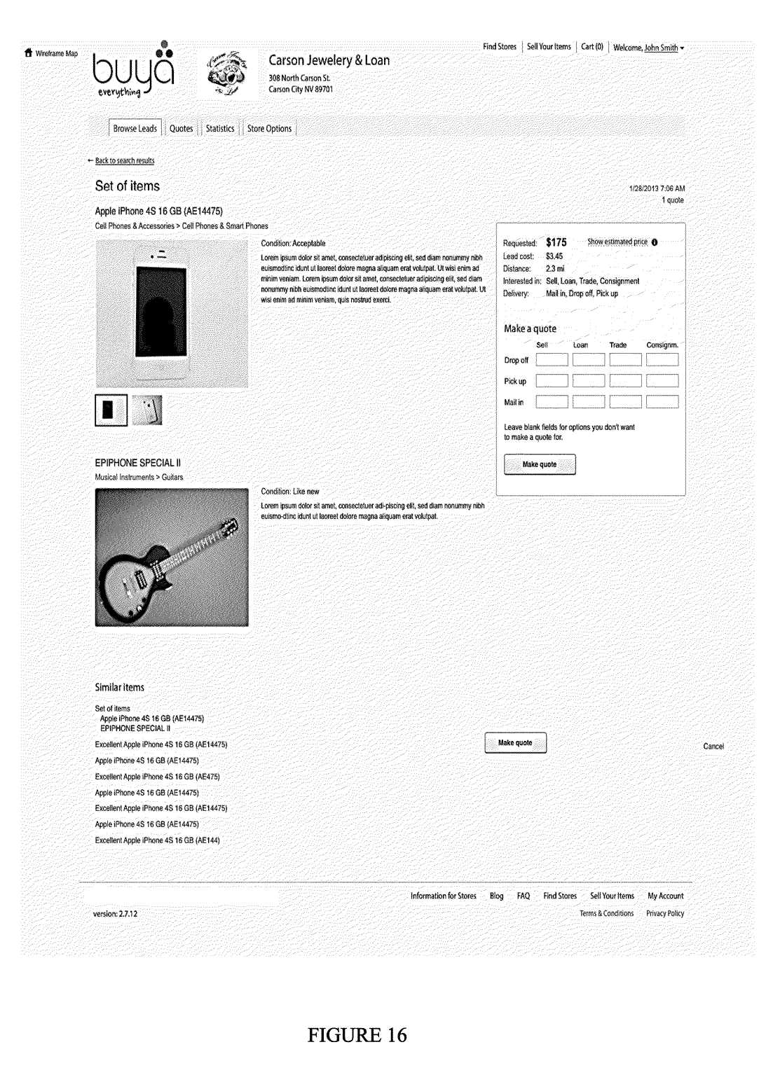

FIGS. 5-16 illustrate exemplary screenshots of web interfaces or pages by which information is presented to a seller or retailer or via which a seller or retailer may interact with the system 100. FIGS. 5 and 6 are exemplary webpages which provide or display explanatory information regarding the system and method of the invention to a seller or retailer. FIG. 7 illustrates an exemplary page for a seller to input contact details and indicate a desired transaction type (such as a sale, loan, trade or donation). FIG. 8 illustrates an exemplary page for a seller to input item details, including photos. FIG. 9 illustrates an exemplary page for a seller to input or designate desired delivery options for the transaction. FIG. 10 illustrates an exemplary page which shows a list of a seller's items, including those which are pending (i.e., awaiting bids) and those transactions which have been accepted. FIG. 11 illustrates an exemplary page which illustrates retailer transactions, including a retailer's quotes which have been accepted by sellers. FIG. 12 illustrates an exemplary page which presents leads to a retailer that the retailer may wish to quote or bid upon. FIG. 13 illustrates an exemplary page by which additional lead details are provided to a retailer. FIG. 14 illustrates an exemplary page showing the stores or locations which a retailer has associated with the system. FIGS. 15 and 16 illustrate exemplary pages showing additional lead details to a retailer.

Each of the exemplary pages shown in FIGS. 5-16 illustrate additional aspects of the invention. For example, as illustrated in FIG. 13, when a lead is presented to a retailer, information may be provided to the retailer beyond just details of the item. For example, a customer rating may be provided (which rating may reflect prior retailer evaluations of the seller, the percentage of times the seller has successfully completed prior transactions or other criteria, etc.), a lead cost (e.g. the cost to the retailer if the retailer quotes and completes the transaction), and other details regarding the proposed transaction (distance the seller is away from the retailer, desired delivery options, etc.).

The system and method may have various other features or configuration and has a variety of other advantages and benefits over the prior art. In one embodiment, the system 125 may be operated by a third party and be configured to generate revenue to support its operation. For example, a retailer may be required to pay a fee to utilize the system, such as to be a registered user. In another embodiment, a retailer may be required to pay a fee if they are selected by a seller as the winning bidder. This fee may be required to be paid by the seller even if the transaction is not ultimately completed with the seller. In the alternative and/or in addition, the seller may be required to pay a transaction fee for each completed transaction as a result of a winning bid through the system 125.

As indicated herein, in one embodiment, any retailer 115 might sign up and utilize the system 125. In other embodiments, a retailer 115 might be required to be vetted or approved in order to utilize the system 125. Such an approval might require, for example, that the retailer 125 meet certain requirements such as bonding, etc., to protect the system operator and/or sellers against unscrupulous or fraudulent retailers.

In one embodiment, if a seller does not receive any desirable bids, the seller may be permitted to resubmit a lead. In such a situation, a seller may be permitted to designate additional criteria for a bid, such as the desire for a particular price in order to accept a bid. For example, if a seller receives a highest bid of $15 for an item but is only willing to sell the item for $17.50, then the seller might seek a re-bid with an indication that a bid of $17.50 would be accepted.

A particular advantage of a preferred embodiment of the invention is that a seller need only provide a picture of an item for sale in order to generate a lead. This greatly simplifies the process of a seller attempting to sell a good as compared to existing systems and methods. Moreover, the methods and systems described herein enable a user to generate a lead, or buy/sell from a mobile device while keeping an updated personal inventory that can be accessed anywhere. For example, while at the mall, a user could buy a new bike and generate a lead for the sale of the user's current bike without having to return home or create burdensome classified ads or possibly forget to sell the old bike. In addition, the mobile customer device described herein enables a user, while travelling, to review bids that each include a distance between the user's current location and the bidder's location to identify a nearby drop-off location for an item.

In one or more embodiments, graphical user interfaces may be utilized to aid the seller in generating a lead, accepting a bid and/or providing follow-up product information. For example, in one embodiment when a seller wishes to generate a lead, the seller may access a webpage or GUI associated with an application. Such an interface may instruct the seller to attach or upload a photograph of the item. When bids are received, the bids may be displayed on an interface an include information such as associated maps (such one or more maps showing the location(s) of the retailers), bid amount and the like. Upon selecting a bid, the seller may be required to provide additional product information. An interface may include drop-down menus which aid a user in selecting and providing the information (such as drop-down menus for selecting categories of goods, models of goods, etc.) and/or open text or free-form entry locations for inputting information.

Another particular advantage of the system and method of the invention is the integration of all aspects of the buying and selling process, wherein a retailer who purchases a good obtains information regarding the good in making the purchase and that same information is used to create an inventory entry for the retailer which is useful for the retailer in re-selling the good at a brick and mortar location or online (for example, information which is provided by a seller regarding their good can be automatically uploaded and populate the retailer's inventory list for the item when the item is purchased by the retailer). In addition, such product or inventory information is used to automatically generate on-line listing information through private portals or public sites such as eBay or the like. Another advantage of the system is that information which is generated during the buying and selling of goods is used to generate value or price estimate information. As a result of large numbers of transactions, smaller retailers thus gain knowledge regarding the value of items, both for purposes of deciding how much to bid for an item and in setting the price of an item for resale. In one or more embodiments, a seller might access or be provided with price estimate information. For example, when one or more bids are returned, a seller might also be provided with information regarding the value of prior winning bids for similar items and/or the list or sales price of similar items which are currently being sold by retailers, thus enabling the seller to assess the received bids against market conditions.

The logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components (including, among other things, engines, layers, and applications), capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “identifying” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the invention may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network. One or more processors may be programmed or configured to execute any of the computer-executable instructions described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method including executing instructions stored on a computer-readable medium, the method comprising:
receiving lead information regarding an item of property of a seller from a computing device;
generating a lead listing based at least in part on the received lead information;
identifying at least one retailer based on the received lead information and at least one buying preference associated with each retailer of a plurality of retailers;
transmitting the lead listing to the identified at least one retailer; and
receiving at least one bid from the identified at least one retailer.

2. A computer-implemented method in accordance with claim 1, further comprising transmitting the at least one bid to the computing device.

3. A computer-implemented method in accordance with claim 2, further comprising receiving a selection of the at least one bid from the computing device.

4. A computer-implemented method in accordance with claim 3, further comprising notifying a selected retailer associated with the selected at least one bid of a successful auction.

5. A computer-implemented method in accordance with claim 1, wherein the at least one bid includes an offer price and a transport method.

6. A computer-implemented method in accordance with claim 1, further comprising identifying an estimated item price based at least on the lead information.

7. A computer-implemented method in accordance with claim 6, wherein the lead listing includes the estimated item price.

8. A computer-implemented method in accordance with claim 6, wherein the estimated item price is based on at least one product attribute associated with the lead information and historical sales data associated with the at least one product attribute.

9. A method of buying goods from sellers for resale via a computing system comprising:
receiving a sales lead regarding an item from a seller, said sales lead comprising at least one photograph of said item for sale by a consumer from a mobile electronic device, said photograph comprising a data file of image information;
relative to a database of retailers, identifying retailers meeting criteria for seeking acquisition of said item;
forwarding a bid request for said item to each identified retailer, said bid request including said at least one photograph of said item;
receiving bids from one or more of said retailers, each bid including bid terms;
forwarding said bids to said seller;
receiving input from said seller of a selected bid which corresponds to a selected retailer; and
notifying said selected retailer of the selection of their bid.

10. The method in accordance with claim 9 further comprising the step of receiving payment from said selected retailer of a bid acceptance fee.

11. The method in accordance with claim 9 further comprising the step of determining product information from said at least one photograph and generating an inventory file regarding said item.

12. The method in accordance with claim 11 further comprising the step of associating said inventory file with said retailer after acquisition of said item.

13. The method in accordance with claim 9 further comprising the step of generating a value estimate for said item from said product information.

14. A computing device including at least one processor and computer-readable instructions that, when executed, cause the at least one processor to:
create an inventory of user items, the inventory of user items having at least one image associated with each user item;
receive a selection of at least one user item;
generate lead information based on the selected as least one user item; and
transmit the lead information to a remote system for generating at least one bid for the lead information.
